(19) United States
(12) Patent Application Publication
(10) Pub. No.: US 2003/0019136 A1
(43) Pub. Date: Jan. 30, 2003

(54) Method and apparatus for advertising

(76) Inventor: James Whitman, Scottsdale, AZ (US)

Correspondence Address: John E Munger, Jansson Shupe & Munger, 245 Main Street, Racine, WI, 53403, US

(21) Appl. No.: 10/203,390

(22) PCT Filed: Feb. 8, 2001
(86) PCT No.: PCT/US01/04248

(30) Foreign Application Priority Data
Feb. 11, 2000 (US) 60181906

(51) Int. Cl. G09F 3/00; G09F 7/12

(52) U.S. Cl. 40/320; 40/594

(57) ABSTRACT

An advertisement-display device (10) and method of advertisement is disclosed. The advertisement-display device (10) is intended for use in displaying advertisement information to passengers within an aircraft. In one embodiment, the advertisement-display device (10) comprises a substrate (77), adhesive (81) on a substrate bottom surface (103) and advertisement indicia (79) on substrate (77). The advertisement indicia (79) is oriented for viewing along substrate top surface (101). The advertisement-display device (10) is attached to a suitable information-display surface (65) on an aircraft tray table (11). The method of advertising includes providing an advertisement-display device (10) and adhering the device (10) to a suitable information-display surface (65) on a tray table (11) within the aircraft so that the advertisement information can be viewed by a passenger on the aircraft.

### FIELD OF THE INVENTION

The present invention relates to methods and apparatus for advertising and presenting information, and, more particularly, to apparatus for displaying and communicating advertisement information to aircraft passengers.

### BACKGROUND OF THE INVENTION

Sellers of goods and providers of services are constantly seeking new and improved ways to expand their businesses by identifying new sources of potential business and by expanding existing business relationships. One potentially significant source of business comprises the men and women who travel on commercial aircraft. Aircraft passengers are a particularly valuable market segment to advertisers because such passengers tend to be more affluent and, as a result, potentially have significant purchasing power. Business people who travel on commercial aircraft can often be responsible for making large-scale purchasing decisions for the person's business.

Aircraft passengers are also of great potential benefit to advertisers because such passengers can advantageously be identified and grouped by demographic data thereby permitting the advertiser to efficiently target its message to the groups of persons most likely to be interested in the advertiser's goods and/or services. Aircraft passengers can be analyzed and grouped demographically based on many different characteristics. For example, aircraft passengers can be identified and targeted for specific advertising messages based on the geographic regions in which the passenger is traveling (e.g., the Pacific Northwest or New England), the time of travel (e.g., weekdays or weekends), and the price point of travel (e.g., first class, business class or coach). Targeted communication of advertising information to aircraft passengers, therefore, benefits both the advertiser and the aircraft passenger as a potential purchaser of the advertiser's goods and/or services.

Advertising to aircraft passengers is also a potentially attractive way for the advertiser to promote goods and/or service because such method of advertising has the potential to be extremely effective—aircraft passengers are, in essence, a captive audience for the advertiser. When passengers are sitting in a seat on an airplane, they may have little to do or look at for a majority of the ride. By placing advertisements on viewable surfaces within the aircraft, the passenger literally cannot escape from reading the advertiser's message.

A number of devices have been proposed in order to present advertisements and information to passengers on commercial aircraft and other forms of public transportation. However, each such device has important disadvantages and limitations.

For example, U.S. Pat. No. 5,010,668 (Zeligson) shows apparatus used to display information on a card through a window provided in the headrest of an aircraft seat or provided in an aircraft seat tray table. The Zeligson device disadvantageously requires excessive amounts of complicated and expensive seat or tray table structure. The window through which the information is displayed can become smudged and dirty during, for example, meal service on the aircraft. The tray table embodiment of the Zeligson includes numerous parting lines and surfaces along which food and other debris will become lodged during use of the tray table. Any such damage or soiling of the Zeligson apparatus would greatly detract from the advertiser's message. Time consuming and costly cleaning efforts are required to keep the apparatus of Zeligson in a neat and presentable condition.

U.S. Pat. No. 5,720,515 (Haffner) also shows apparatus used to display information through a window in a seat back or tray table. Like Zeligson, Haffner requires unduly complex and costly structure, such as customized seating and tray table components. The window through which the information is viewed can become dirty or smudged, particularly in the tray table embodiments. Also like Zeligson the tray table embodiments include parting lines and surfaces along which food or liquid will disadvantageously become lodged during use. Again, constant cleaning is required to maintain the cleanliness of such apparatus. Failure to maintain the cleanliness of the apparatus would minimally detract from the Advertiser's message and could result in important adverse health consequences.

U.S. Pat. Nos. 2,517,433 (Hoven, et al.) and 1,612,574 (Golden) show apparatus used to display information from a seat back panel attached to seats used in buses. In each embodiment shown, an information-containing panel is mechanically secured to the seat back by permanently-affixed panel support structure. The affixed support structure is costly and time-consuming to install and, especially, to remove. The information-containing panel is limited with respect to its size and shape by the support structure within which the panel is mounted to the seat back. The devices of Hoven and Golden would not be suitable for use on the top surface of a tray table because the bulky structure of these devices would create obstructions and surfaces impairing use of the table.

U.S. Pat. Nos. 5,813,748 (Maxymych), 4,928,411 (Danis, et al.) and 4,640,033 (Bulger) show portable tray devices including some sort of information display. Maxymych and Danis display information on a placard through a window while Bulger is a child's food serving tray including graphic matter or electric lights. These portable devices are potentially difficult to clean and, because they are portable and transient, are of limited value to an advertiser because the advertiser's message would be seen by the user for only a limited amount of time.

Any advertiser potentially contemplating the notion of advertising on commercial aircraft faces many important problems and obstacles. For example, a complicating factor with respect to the possible use of aircraft tray tables (i.e., the tables secured, for example, to the aircraft seats, aircraft seat armrests or other aircraft structure) as potential surfaces on which advertising information could be displayed is the fact that such tables are provided in many different shapes, sizes and configurations depending on the type of aircraft on which the tables are used. For example, tray tables used on the Airbus Industries A-320 aircraft have softly curved front edge surfaces facing the passenger while tray tables used on other aircraft may utilize more rectangular configurations with linear outer edge surfaces. These aircraft tray tables may have single or plural table top surfaces.

Tray table top and bottom surfaces also vary greatly. Some table tops have planar surfaces while others include recessed and protruding portions, for example a recessed cup holder area or a protruding lip portion to prevent dishes from falling into the passenger's lap. The tray table surfaces may also be made of varying materials such as plastic or metals. Any advertisement contemplated for use on an aircraft tray table must be capable of economical use with these many different tray table configurations and materials.

The advertiser must also consider that the ideal advertisement device for use on an aircraft must be easy to affix to the selected aircraft display surface and must also be easy to remove so that another advertisement could be quickly affixed to the display surface. The advertisement device must be made of a sturdy material with few parts and components. The advertisement device must be capable of attractively displaying the advertiser's advertisement including the many different forms of text, computer-generated graphics and art work commonly used in modem advertising. The advertisement device should also be capable of easy cleaning with mild detergents.

In addition, the advertisement device must be compliant with applicable rules and regulations regarding the types of materials that can be used on aircraft. For example, any advertisement device contemplated for use on a commercial aircraft must comply with Federal Aviation Administration (“FAA”) Federal Aviation Regulations (“FAR”) regarding flammability.

A method of advertising and advertising device which could be easily affixed to display surfaces secured within an aircraft to provide advertising information to aircraft passengers, which would provide the advertiser with great flexibility with respect to type of promotional information which could be displayed, which would have few components, which would be simple to use and clean and which would be economical would represent an important advance in the art.

### OBJECTS OF THE INVENTION

It is an object of this invention to provide an improved method and apparatus for advertising which overcome some of the problems and shortcomings of the prior art.

Another object of this invention is to provide an improved method and apparatus for advertising which permits the advertiser to effectively communicate promotional information to aircraft passengers.

It is also an object of the invention to provide an improved method and apparatus for advertising wherein the apparatus can attractively display the advertiser's message including the many different forms of text, computer-generated graphics and art work commonly used in modern advertising.

Still another object of this invention is to provide an improved method and apparatus for advertising which can be easily configured to fit the unique and varied configurations of tray tables used on commercial aircraft.

A further object of the invention is to provide an improved method and apparatus for advertising including use of apparatus which includes a minimal number of components.

An important object of the invention is to provide an improved method and apparatus for advertising which is economical to manufacture and use.

Yet another object of the invention is to provide an improved method and apparatus for advertising wherein the apparatus is durable and suitable for use in commercial aircraft.

A further object of the invention is to provide an improved method and apparatus for advertising wherein the apparatus is easy to apply to, and remove from, aircraft surfaces.

Another object of this invention is to provide an improved method and apparatus for advertising including apparatus which can be easily cleaned of food, liquid and other substances.

It is also an object of the invention to provide an improved method and apparatus for advertising, wherein the apparatus is strictly compliant with FAA rules and regulations, including regulations with respect to material flammability.

One additional object of the invention is to provide an improved method and apparatus for advertising including use of chemical agents provided to emit fragrances and other compounds to improve the aircraft cabin air quality.

How these and objects of the invention are accomplished will be apparent from the following descriptions and from the drawings.

### SUMMARY OF THE INVENTION

The invention comprises apparatus for displaying advertisement information on an aircraft tray table along a tray table advertisement-display surface and a method of advertising using such apparatus. The apparatus and method provide a powerful vehicle for advertisers to reach aircraft passengers who will view the advertisement along the tray table surfaces during the course of the flight. The apparatus is simple and economical to use.

In general, the apparatus includes a substrate, advertisement indicia on the substrate and an adhesive for securing the substrate directly to the aircraft tray table advertisement-display surface. The preferred substrate has top and bottom sides, top and bottom substrate surfaces and is sized for attachment to the tray table advertisement-display surface. The substrate can comprise a single substrate sheet (also referred to as element) or could comprise plural sheets (i.e., elements) forming a laminate. A broad range of materials are useful in making the substrate and such materials preferably include vinyl, polyvinyl chloride, polypropylene, polyester, polystyrene, nylon, polycarbonate and lexan.

The advertisement indicia are provided on the substrate and are oriented to be viewable by a passenger along the substrate top surface. The advertisement indicia are intended to include promotional matter of any kind including matter other than of a purely commercial nature. Such promotional information could include, for example, a public service announcement or the like. The invention permits great creativity in the type of indicia which may be used thereby permitting ample opportunity to present the advertiser's message in a highly creative manner.

Adhesive is provided on the substrate bottom surface for securing the substrate directly to the aircraft tray table advertisement-display surface. Use of adhesive as an attachment mechanism permits simple and rapid installation and removal of the apparatus by trained personnel. It is very highly preferred that a release liner be removably affixed to the substrate bottom surface during or after manufacture and before use in order to facilitating handling of the apparatus and to avoid premature attachment of the device to a surface other than the advertisement-display surface of interest.

The apparatus is applied to advertisement-display surfaces along one or both of the aircraft tray table top or bottom surfaces. The apparatus may be sized and configured to closely match the shape and contours of the advertisement display surface providing an appearance that the apparatus and tray table are an integral unit.

The advertising method of the invention comprises the steps of providing an advertisement-display device including the substrate, advertising indicia and adhesive such as described herein and adhering the advertisement-display device directly to a tray table advertisement-display surface by applying the adhesive-containing substrate bottom surface directly to the advertisement-display surface. Preferably, the substrate and adhesive are selected such that the substrate can be peeled off the aircraft advertisement-display surface and the adhering step comprises removably adhering the advertisement-display device directly to the advertisement-display surface. If a release liner is supplied then the liner is removed before the applying step. The method permits the advertiser's message to be prominently positioned directly in front of a passenger seated in the aircraft.

The apparatus may optionally include fragrance-containing compounds so as to provide a desired scent within the aircraft cabin. The apparatus is compliant with FAA regulations with respect to materials used in the aircraft cabin.

### BRIEF DESCRIPTION OF THE DRAWINGS

Additional aspects of the present invention will become evident upon reviewing the non-limiting embodiments described in the specification and the claims taken in conjunction with the accompanying figures, wherein like numerals designate like elements; and

FIG. 1 is a perspective view of an exemplary advertisement device of the invention shown attached to an advertisement-display surface along the top surface of an aircraft tray table.

FIG. 2 is a perspective view of an exemplary advertisement device of the invention shown attached to an advertisement-display surface along the bottom surface of an aircraft tray table.

FIG. 3 is the aircraft tray table of FIGS. 1 and 2 showing an exemplary advertisement-display device of the invention configured to fit a contoured advertisement-display surface along the tray table top surface.

FIG. 4 is the aircraft tray table of FIGS. 1 and 2 showing an exemplary advertisement-display device of the invention configured to fit a contoured advertisement-display surface along the tray table bottom surface.

FIG. 5 is an aircraft tray table from an Airbus Industries A-320 aircraft showing an exemplary advertisement-display device of the invention configured to fit a contoured advertisement-display surface along the tray table top surface.

FIG. 6 is a sectional illustration of the tray table and advertisement-display devices of FIGS. 3 and 4 taken along line 6-6 of FIG. 3.

FIG. 7 is an enlarged fragmentary sectional illustration of an exemplary advertisement-display device taken along a portion of line 6-6 of FIG. 3.

FIG. 8 is an enlarged fragmentary sectional illustration of another exemplary advertisement-display device taken along a portion of line 8-8 of FIG. 5.

### DETAILED DESCRIPTION OF EXEMPLARY EMBODIMENTS

The following descriptions are only of exemplary embodiments of the invention, and are not intended to limit the scope, applicability, or configuration of the invention in any way. Rather, the following description is intended to provide convenient illustrations for implementing different embodiments of the invention. As will become apparent, various changes may be made in the function and arrangement of the elements described in these embodiments without departing from the spirit and scope of the invention.

The following detailed description will focus on exemplary embodiments 10, 10′ and 10 ″ and the related exemplary structure provided to practice the advertising method of the invention. It will be readily understood that like reference numbers which incorporate a prime number symbol are intended to reference like structure on the alternative embodiments including all supporting descriptive and illustrative information.

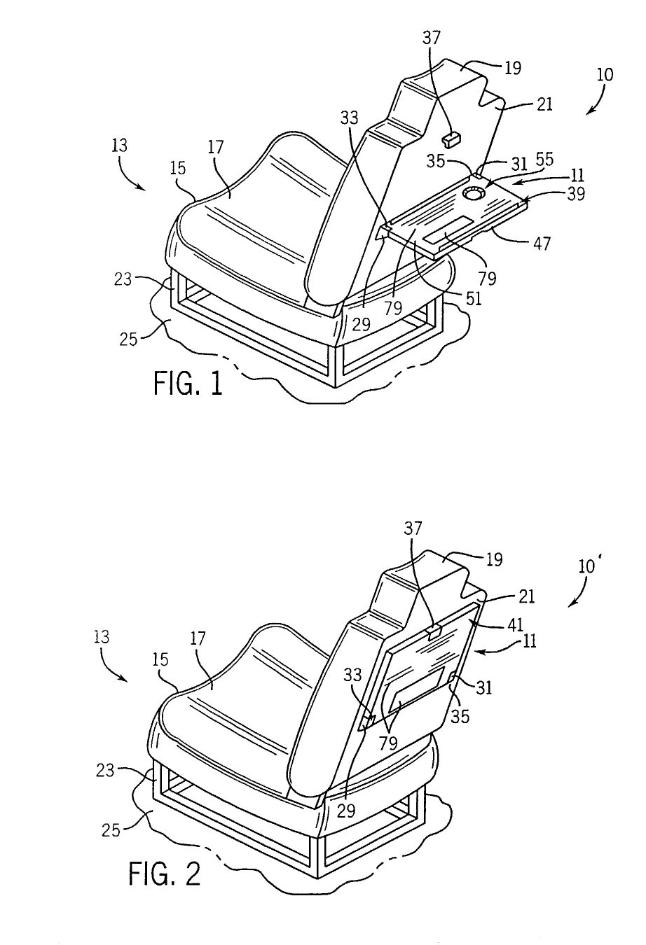

Referring first to FIGS. 1 and 2, those figures show separate embodiments of the invention 10 and 10′ secured along respective sides of an exemplary aircraft tray table 11 secured along aircraft seat 13. Aircraft seat 13 is provided with a seat cushion 15 which has a seat surface 17. Seat 13 further includes a seat back 19 with a seat back surface 21. A seat support frame 23 is positioned within and below seat 13 for supporting seat cushion 15, seat back 19, and for securing seat 13 to the aircraft cabin floor 25.

Positioned along the seat back surface 21 is a tray table 11. Tray table 11 is supported with respect to seat support frame 23 by arms 29, 31. Each arm 29, 31 is secured to seat 13 by suitable means and is attached to tray table 11 at a respective articulated joint 33, 35.

The exemplary articulated arm structure described above permits tray table 11 to be pivotally moved back-and-forth between the “use” position shown in FIG. 1 and the “stowed” position shown in FIG. 2. In the use position, movable latch 37 is desecured from tray table 11 permitting tray table 11 to be lowered into position for use by a passenger seated behind seat 13. In the stowed position, tray table 11 is raised and secured in an upright position by movable latch 37 along seat back 19 thereby positioning tray table 11 out of the way of such passenger.

Referring now to FIGS. 1-6, tray table 11 is provided with top and bottom sides 39, 41. Tray table 11 further includes side edge surfaces 43, 45 and front and rear edge surfaces 47, 49. Tray table top and bottom sides 39, 41 include respective top and bottom surfaces 51, 53 defined by the tray table length (i.e., the distance between side edge surfaces 43, 45) and width (i.e., the distance between front and rear edge surfaces 47, 49). Tray table top and bottom surfaces 51, 53 are typically made of plastic or lightweight metal materials, such as aluminum.

Tray table top and bottom surfaces 51, 53 may be substantially planer or may include recessed or protruding portions. For example, and as shown in FIGS. 1, 3 and 6, tray table top surface 51 includes an annular recessed portion 55 provided for use as a cup holder. Recessed portion 55 includes a bottom surface 57 and annular beveled side walls 59.

Tray table top surface 51 further includes a raised lip portion 61 formed along top surface 51 proximate front edge surface 47. Lip portion 61 provides a barrier preventing dishes and food on tray table top surface 51 from sliding off of the tray table 11 and onto the lap of the passenger using tray table 11 and seated behind seat 13.

Tray table bottom surface 53 may also have non-planer surface portions and may incorporate, for example, a recessed portion 63 provided to receive latch 37 for purposes of securing tray table 11 in the stowed position of FIG. 2.

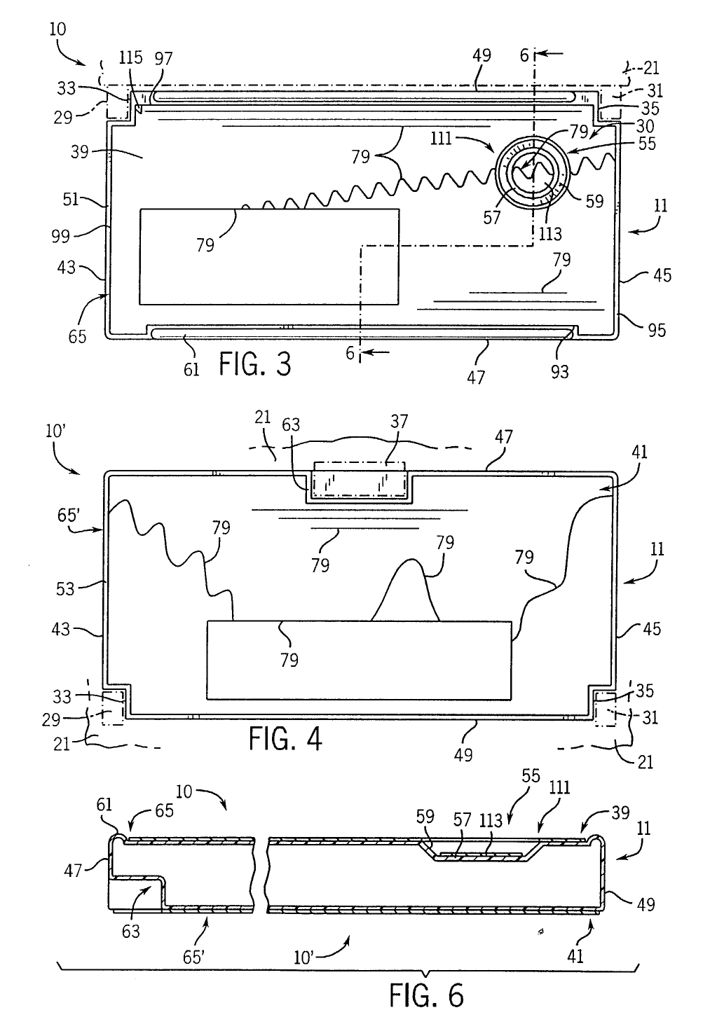

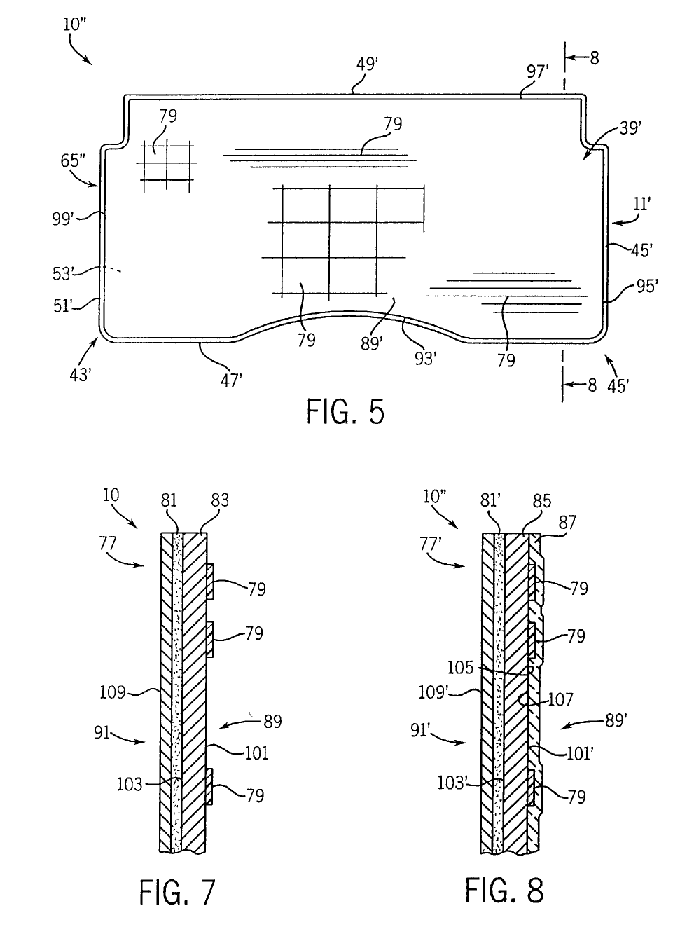

The exemplary tray table 11′ shown in FIG. 5 is typical of the tray tables used on Airbus Industries A-320 aircraft and is shown to illustrate the varied shapes of tray tables used in the commercial aviation industry. Tray table 11′ is provided with a top surface 51′ which is generally planar and does not include the recessed and protruding portions of tray table 11 of FIGS. 1 and 3. Tray table 11′ may be further distinguished from tray table 11 because front edge surface 47′ and side edge surfaces 43′, 45′ are softly contoured and rounded. While not illustrated, tray table 11′ also has a bottom surface 53′ facing the passenger behind seat 13 when the tray table 11′ is in the stowed position similar to that shown in FIG. 2. Bottom surface 53′ may be provided with any suitable surface configuration.

A first advertisement-display surface 65 may be provided along some, and preferably substantially all, of tray table top surface 51 for receiving an advertisement-display device 10 of the invention. Advertisement-display surface 65 is prominently positioned directly in front of the passenger seated behind seat 13 when tray table 11 is in the use position of FIG. 1. A second advertisement-display surface 65′ may be provided along some or all of tray table bottom surface 53 and such surface is prominently positioned directly in front of a passenger seated behind seat 13 when the tray table 11 is in its stowed position. Thus, exemplary tray table 11 could include respective advertisement-display surfaces 65 and 65′ along one or both of the tray table top and bottom surfaces 51, 53. It is envisioned that other advertisement-display surfaces could be positioned along tray table 11 such as, for example, a display surface positioned on a panel (not shown) which folds out from the tray table top surface 51 when the table is in its use position.

An exemplary advertisement-display device 10 (or 10′, 10″) useful in practicing the method of the invention will now be described particularly with respect to FIGS. 7 and 8. Exemplary advertisement-display device 10 comprises a substrate 77, advertisement indicia 79 on substrate 77 and adhesive 81 secured along substrate 77 for removably securing device 10 to a suitable aircraft advertisement-display surface 65.

Substrate 77 may be provided as a single substrate element 83 (FIG. 7) or as a laminate substrate 77′ including plural substrate elements, such as elements 85 and 87 (FIG. 8). First and second elements 85, 87 may be secured one to the other by any suitable means known to those of skill in the art.

Substrate 77 includes top and bottom sides 89, 91, and edge surfaces 93-99. Substrate top and bottom sides 89, 91 include top and bottom surfaces 101, 103 defined by the substrate length (i.e., the distance between edge surfaces 93, 95) and substrate width (i.e., the distance between edges 97, 99).

Substrate 77 is made of a thin material and has a preferred substrate thickness (i.e., the distance between top and bottom side surfaces 101, 103) in the range of between about 1 to 8 mils. As shown in the laminate of FIG. 8, first element 85 has a top surface 105 and element 87 has a bottom surface 107.

A wide range of materials are useful in manufacture of the substrate 77 including vinyl, polyvinyl chloride, polypropylene, polyester, polystyrene, nylon, polycarbonate and lexan. Polymeric films are highly preferred because they are rugged, stain resistant and are easily cleaned of food and other substances by hand washing with a mild detergent. A particularly preferred material for use as substrate element 83 or 85 is Controltac™ Series 180 film available from the 3M® Company of St.Paul, Minn. The Series 180 film is an adhesive coated polyvinyl chloride film with a release liner and a film thickness of about 2 mils.

The laminate substrate 77′ of FIG. 8 includes first element 85 comprising the 3M Series 180 film bonded to second element 87 comprising “Matt 3 mil. Cold Laminate film” which is a product of General Binding Corporation of Northbrook, Ill. (“GBC”). The GBC film is a translucent, adhesive coated polyvinyl chloride film with a release liner and a film thickness of about 3 mils. In this embodiment, the Series 180 film first element 85 top side 105 is pressed against second element 87 adhesive containing bottom side 107 of the GBC film at a pressure of about 50-120 psi to form a laminate having an approximate thickness of about 5 mils. This laminate form of substrate 77′ is advantageous because the translucent second element 87 serves as a protective “lens” through which indicia 79 can be viewed along top surface 89′ of FIG. 5. Such laminate structure is highly desirable because it protects the advertisement device 10 from damage and degradation thereby enhancing the quality and appearance of the advertiser's message.

FIGS. 7 and 8 also show adhesive 81 or 81′ provided along substrate bottom surface 103 for securing advertisement-display device 10 (or 10′, 10″) to an appropriate advertisement-display surface, such as surface 65. The adhesive may be acrylic-based or may be of another suitable composition. Adhesive 81 is selected to have sufficient adhesion characteristics so that the advertisement-display device 10 is: (a) securely adhered to advertisement-display surface 65 and cannot be easily removed by an aircraft passenger; yet (b) can be peeled off an the advertisement-display surface 65 by a maintenance person. Adhesion characteristics in the range of about 4 to 6 pounds/inch are highly preferred.

3M® Series 180 film is supplied from the manufacturer with a suitable adhesive coating having adhesion characteristics within the 4 to 6 pounds/inch range depending on the surface to which the Series 180 film is applied. For example, the Series 180 film has adhesion characteristics of 4 pounds/inch when adhered to ABS or acrylic enamel substrates and 6 pounds/inch when adhered to etched or anodized aluminum substrates. Such adhesion characteristics are a standard industry measure of the amount of force required to remove a conditioned 1 inch wide film specimen from the substrate 24 hours after attachment of the film to the substrate. The film is pulled at an angle of 180° from the substrate at a rate of 12 inches/minute. The adhesion characteristic of the film represents the amount of force required to begin to remove the 1 inch wide film from the substrate. Adhesion characteristics below and above the 4-6 pounds/inch range are also anticipated to operative with respect to the adhesive used in the invention. Desirably, the Series 180 film does not leave an adhesive residue on the advertisement-display surface following removal.

A release backing 109 shown in FIGS. 7 and 8 may be applied over adhesive 81 to prevent adhesive 81 from undesirably bonding to a surface other than the desired advertisement-display surface and permits ease of handling and use prior to actual application of advertisement-display device 10 to the desired surface 65. Release backing 109 is selected so that it may be easily peeled away from advertisement device 10 just prior to application of the substrate bottom side 91 and the adhesive 81 attached to bottom surface 103 to advertisement-display surface 65. Adhesive 81 could also be applied in any other suitable manner, including by applying adhesive 81 directly to substrate bottom surface 103 just prior to attachment of advertisement-display device 10 to advertisement-display surface 65.

FIGS. 1-8 show advertisement indica 79 applied to substrate 77 for viewing by an aircraft passenger along substrate top surface 101. Indicia 79 can include, for example, graphic matter of any suitable type including text, art work, photographs and computer-generated graphics. Advertisement indicia 79 are intended to include promotional matter of any kind including matter other than of a purely commercial nature, for example, a public service announcement. Such arrangement provides advertisers with great creative flexibility to craft the form and content of the indicia 79. Indicia 79 may be applied in any suitable manner including along top 101, 105 and/or bottom 103, 107 surfaces or formed into substrate elements 83, 85, 87. By way of example only, advertisement indicia 79 can be applied to substrate element 85 top surface 105 by means of a digital print process or by means of a four color screen print process. In the digital print process the indicia are thermally applied to substrate element 83 or 85 by a printer apparatus while in the four color process the four colors comprising the indicia (cyan, magenta, yellow and black) are applied to such substrates stepwise using a negative screen element for each color to be applied. Desirably, a transparent second substrate element 87 may be applied over indicia 79 as described above to provide a protective surface over indicia 79. In a reverse printing process, indicia 79 may be applied along substrate bottom surface 103 or 103′ before application of adhesive 81 to the bottom surface. Other means of applying indicia 79 known to those of skill in the art may be utilized.

As is apparent from the configurations of the advertisement-display devices 10, 10′ and 10″ shown in FIGS. 1-6, substrate 77 comprising advertisement-display device 10 is preferably sized for attachment to the respective advertisement-display surface 65, 65′ or 65″. Preferably substrate 77 is die cut so as to closely or exactly conform to the shape of the advertisement-display surface 65, 65′ or 65″. For example, substrate 77 could be die cut to conform closely to the top surface 51, 51′ of respective tray table 25, 25′ as shown in FIGS. 3 and 5. It should be noted that other means of sizing advertisement device 10, such as by cutting with laser-cutting apparatus, may be utilized to obtain the desired configuration.

Substrate 77 may also be die cut to fit the non-planar surface portions of advertisement-display surface 65 of FIGS. 1 and 3. For example, and as shown in FIG. 3, substrate 77 may be die cut to include a circular opening 111 corresponding to tray table annular recessed portion 55 and may further include a substrate portion 113 provided for attachment along recessed portion bottom surface 57. Further, substrate 77 can be die cut to position substrate 77 around protruding lip 61 provided in tray table top surface 51.

Die cutting of substrate 77 to closely conform to tray table top surface 51 is advantageous for several reasons. Closely conforming substrate 77 to top surface 51 is aesthetically pleasing because it creates the appearance that advertisement-display device 10 and respective tray table 25 are a unitary structure. Such die cutting process is advantageous for utilitarian reasons because substrate 77 can be sized to fit many differently-shaped advertisement-display surfaces, such as surfaces 65, 65′ or 65″. Edge surfaces 93-99 may be die cut with a slight bevel (not shown) to smooth the transition between the tray table top surface 51 and substrate 77 making the advertisement-display device 10 more aesthetically attractive and difficult to remove in an unauthorized manner.

The sizing operation may also include removing a small recessed portion 115 (FIG. 3) along one edge 93-99 of substrate 77. This recessed portion 115 is designed for the purpose of allowing trained personnel to insert a flat removal tool (not shown) between substrate bottom surface 103 and, for example, the tray table top surface 51, for purposes of peeling advertisement-display device 10 away from tray table 25.

Optionally, and depending on the material selected for use as substrate 77, certain fragrance-containing compounds may be applied to the substrate for the purpose of improving the scent of the aircraft cabin air.

Advertisement-display device 10, 10′ and 10″ is compliant with US FAR §25.853 governing materials permitted for use in aircraft compartment interiors and is suitable for use on a commercial aircraft. To determine compliance with §25.853 a flammability evaluation was conducted with an exemplary advertisement-display device 10 comprising a laminate of 3M® Controltac Series 180 film and GBC Matt 3 mil. Cold Laminate film. A further flammability evaluation was conducted of an identical advertisement-display device attached to a tray table, such as table 11.

The advertisement-display device (excluding a tray table) was subjected to 15 second horizontal burn tests according to US FAR 25-82, Appendix F, Part 1, Paragraph (a)(1)(iv), Procedure (b)(5). The advertisement-display device (including the tray table) was subjected to 12 second vertical burn tests according to Appendix F, Part 1, Paragraph (a)(1)(ii), Procedure (b)(4). The release paper backing for the apparatus 10 was, in both sets of tests, removed prior to testing.

The vertical and horizontal burn tests were performed by applying a 1″ long burner flame to horizontally oriented samples of the advertisement-display device and vertically oriented specimens comprising the advertisement-display device and tray table. The flame was applied for 30 seconds and had a temperature of approximately 1620° F. The distance of flame travel was then measured from the initial point of flame contact to the point where the flame self-extinguished. The burn rate was then calculated in units of inches traveled/minute.

Six trials were performed in each of the vertical and horizontal burn tests, three trials from each opposite end of the vertically or horizontally oriented specimens. Observations were made with respect to the burn movement and nature of the flame. The data are presented in Tables 1 and 2 below.

TABLE 1
Horizontal Burn Test
Advertisement-Display Device Excluding Tray Table

| | | Burn Rate | | |
|---|---|---|---|---|
| | | (Inches./ | Requirement | |
| Direction | Specimen No. | Minute.) | (Maximum) | Compliance |
| 1 | −1 | 0.0 (SE) | | |
| 1 | −2 | 0.0 (SE) | | |
| 1 | −3 | 0.0 (SE/NBR) | | |
| 2 | −1 | 0.0 (SE) | | |
| 2 | −2 | 0.0 (SE) | | |
| 2 | −3 | 0.0 (SE) | | |
| Average | * * | 0.0 | 2.5 inches/ | Pass |
| | | | minute | |

The horizontal burn test data of Table 1 show that the exemplary advertisement-display device alone was compliant with FAA horizontal burn regulations required for use of materials on commercial aircraft. The device had essentially no horizontal burn. Trials 1-2 and 4-6 demonstrated that the device was self extinguishing meaning that the material ignites on either surface, but the flame extinguishes before reaching the 1.5 inch gauge mark. In trial 3, the device was self extinguishing with no burn rate. The material stopped burning before it burned for 60 seconds from the start of timing and did not burn more than two inches from the point where timing was started. No calculation of burn rate was required.

TABLE 2
Vertical Burn Test
Advertisement-Display Device Including Tray Table

| | | | | Drip | |
|---|---|---|---|---|---|
| | | | Burn | Extin- | |
| | Specimen | Afterflame | Length | guishing | Comp- |
| Direction | No. | (seconds) | (inches) | (seconds) | liance |
| 1 | −1 | 0.0 | 0.5 | 0.0 | |
| 1 | −2 | 0.0 | 0.5 | 0.0 | |
| 1 | −3 | 0.0 | 0.5 | 0.0 | |
| 2 | −1 | 0.0 | 0.3 | 0.0 | |
| 2 | −2 | 0.0 | 0.3 | 0.0 | |
| 2 | −3 | 0.0 | 0.3 | 0.0 | |
| Average | * * | 0.0 | 0.4 | 0.0 | Passed |
| Requirements | * * | 15.0 | 8.0 | 5.0 | * * |
| (Maximum, | | seconds | inches | seconds | |
| Average) | | | | | |

The vertical burn test data of Table 2 show that the table-mounted advertisement-display device and table were compliant with FAA vertical burn standards and would be suitable for use on a commercial aircraft. The specimens had an average burn length of only 0.4 inches and had essentially no afterflame or drip extinguishing. Drip extinguishing refers to the burn properties of material which “drips” from the specimen following application of the flame. The data show that any dripped material immediately self-extinguished.

The above-described advertisement-display device 10 (or 10′, 10″) is used to practice the advertising method of the invention. The method comprises the step of providing an advertisement-display device 10 manufactured according to the examples described above. Next, the advertisement-display device 10 is adhered directly to the advertisement-display surface 65 (or 65′, 65″) by applying the adhesive-containing substrate 77 bottom surface 103 directly to the advertisement-display surface 65. Preferably, the adhesive 81 is covered by a release backing 109 and that backing 109 is removed before the adhering step. Preferably, the advertisement-display device 10 includes an adhesive 81 selected as described above such that advertisement-display device 10 is removably secured to the advertisement-display surface 65 and can be peeled off of such display surface by appropriate personnel within seconds using appropriate an appropriate removal tool or technique.

By securing the advertisement-display device 10, 10′, 10″ to the appropriate surface 65, 65′ or 65″ the advertisement indicia 79 is readily viewable within the aircraft cabin by the aircraft passenger. For example, an advertisement-display device 10′ positioned on display surface 65′ would be directly and prominently positioned in front of a passenger seated behind seat 13 during the entire time that the tray table 11 is in the stowed position of FIG. 2. By way of further example, an advertisement-display device 10 positioned on display surface 65 would be prominently positioned on the tray table top surface 51 in the direct view of the same passenger during the entire time that tray table 11 is in the use position of FIG. 1, provided, of course, that objects are not placed over advertisement-display device 10. This novel method of advertising would almost certainly communicate the advertiser's message to the aircraft passenger, and potential customer, throughout the entire course of the aircraft flight. This prolonged exposure would enhance the effectiveness of the advertisement.

Thus, the apparatus of the present invention suitably provides the benefit of permitting advertisers to target the potentially lucrative aircraft passenger market segment and to further target demographic groups of aircraft travelers based on common characteristics, such as their mode of aircraft transportation and/or their destinations. To illustrate one potential example of the novel advertising method, hotels, rental car companies, restaurants, and the like at an aircraft destination city might contract for advertising space on that aircraft using the novel advertisement-display device 10. Such method of advertisement would allow passengers to learn of the amenities available at the destination city and would permit the aircraft passengers to call those advertisers from the aircraft via passenger cell phones or from telephones provided on the aircraft by the air carrier. After landing, and before new passengers board the aircraft, the advertisement-display devices 10 could be quickly removed and replaced by maintenance personnel to provide advertisements for vendors at the aircraft's next destination.

Additionally, according to another aspect of the present invention, there are potential health advantages to this method of advertising because the advertisement-display devices 10 can be easily replaced or cleaned with mild detergent upon reaching the destination. The design of the advertisement-display device 10 also furthers cleanliness and minimizes required maintenance because the device does not include parting lines and debris-accumulating surfaces typical of prior art devices.

The simplicity and ease of use of advertisement-display device 10, the ability of the device 10 to accommodate the many different forms of graphic information and design comprising the advertiser's message and the device's ability to powerfully communicate that subject matter to an aircraft passenger represent an important improvement in the art.

Lastly, while the principles of the invention have been described in illustrative embodiments, it should be apparent that many modifications of structure, arrangement, proportions, the elements, materials and components used in the practice of the invention and not specifically described, may be varied and particularly adapted for specific applications and operating requirements without departing from those principles.

What is claimed is:

1. A device for displaying advertisement information on an aircraft tray table along a tray table advertisement-display surface comprising:
a substrate having top and bottom sides and top and bottom substrate surfaces, the substrate being sized for attachment to the tray table advertisement-display surface;
advertisement indicia on the substrate, the indicia being oriented to display the advertisement indicia along the substrate top surface; and
an adhesive on the substrate bottom surface for securing the substrate directly to the aircraft tray table advertisement-display surface.

2. The device of claim 1 wherein the tray table advertisement-display surface comprises an aircraft tray table top surface.

3. The device of claim 1 wherein the tray table advertisement-display surface comprises an aircraft tray table bottom surface.

4. The device of claim 1 wherein the substrate comprises plural sheets forming a laminate and the advertisement indicia are on at least one of the sheets.

5. The device of claim 1 wherein the substrate is made of a material selected from the group consisting of vinyl, polyvinyl chloride, polypropylene, polyester, polystyrene, nylon, polycarbonate and lexan.

6. The device of claim 1 wherein the substrate is made of a material which is self-extinguishing when exposed to flame at a temperature of approximately 1600° Fahrenheit.

7. The device of claim 1 further including a release liner removably affixed to the substrate bottom surface.

8. The device of claim 1 further including a fragrance-containing compound applied with respect to the substrate.

9. A method of providing advertisement indicia to an aircraft passenger within an aircraft comprising the steps of:
providing an advertisement-display device comprising:
a substrate having top and bottom sides, and top and bottom side surfaces, the substrate being sized for attachment to an advertisement-display surface along a tray table within the aircraft;
advertisement indicia on the substrate, the advertisement indicia being oriented to be viewable along the substrate top surface; and
an adhesive on the substrate bottom surface for securing the substrate directly to the advertisement-display surface; and
adhering the advertisement-display device directly to a tray table advertisement-display surface by applying the adhesive-containing substrate bottom surface directly to the advertisement-display surface;
whereby the advertisement indicia is viewable along the tray table by a passenger within the aircraft.

10. The method of claim 9 wherein:
the substrate and adhesive are selected such that the substrate can be peeled off the aircraft advertisement-display surface; and
the adhering step comprises removably adhering the advertisement-display device directly to the advertisement-display surface.

11. The method of claim 9 further including a release liner removably attached to the substrate bottom surface, and, before the adhering step, the further step of removing the release liner.

12. The method of claim 9 wherein the substrate comprises plural sheets forming a laminate and the indicia are applied to at least one of the sheets.

13. The method of claim 9 wherein the advertisement-display surface comprises an aircraft tray table top surface.

14. The method of claim 9 wherein the advertisement-display surface comprises an aircraft tray table bottom surface.

15. The method of claim 9 wherein the advertisement-display surface comprises both an aircraft tray table top and bottom surface.

16. The method of claim 9 wherein the substrate is made of a material selected from the group consisting of vinyl, polyvinyl chloride, polypropylene, polyester, polystyrene, nylon, polycarbonate and lexan.

17. The method of claim 9 wherein the substrate is made of a material which is self-extinguishing when exposed to flame at a temperature of approximately 1600° Fahrenheit.

18. The method of claim 9 wherein the substrate further includes a fragrance-containing compound applied with respect to the substrate.

19. A device for displaying advertisement information on a vehicle tray table along a tray table advertisement-display surface comprising:
a substrate having top and bottom sides and top and bottom substrate surfaces, the substrate being sized for attachment to the tray table advertisement-display surface;
advertisement indicia on the substrate, the indicia being oriented to display the advertisement indicia along the substrate top surface; and
an adhesive on the substrate bottom surface for securing the substrate directly to the tray table advertisement-display surface.

20. A method of providing advertisement indicia to a passenger within a vehicle comprising the steps of:
providing an advertisement-display device comprising:
a substrate having top and bottom sides, and top and bottom side surfaces, the substrate being sized for attachment to an advertisement-display surface along a tray table within the vehicle;
advertisement indicia on the substrate, the advertisement indicia being oriented to be viewable along the substrate top surface; and
an adhesive on the substrate bottom surface for securing the substrate directly to the advertisement-display surface; and
adhering the advertisement-display device directly to a tray table advertisement-display surface by applying the adhesive-containing substrate bottom surface directly to the advertisement-display surface;
whereby the advertisement indicia is viewable along the tray table by a passenger within the vehicle.
